(19) United States
(12) Patent Application Publication
(10) Pub. No.: US 2026/0320090 A1
(43) Pub. Date: Oct. 15, 2026

(54) GENERATIVE AI ORCHESTRATION SYSTEM, GENERATIVE AI ORCHESTRATION METHOD, AND PROGRAM

(71) Applicant: Hitachi, Ltd., Tokyo (JP)

(72) Inventor: Taro MORI, Tokyo (JP)

(21) Appl. No.: 19/542,239

(22) Filed: Feb. 17, 2026

(30) Foreign Application Priority Data
Apr. 10, 2025 (JP) 2025-064760

(51) Int. Cl. G06F 16/3329

(52) U.S. Cl. CPC G06F 16/33295

(57) ABSTRACT

A generative AI orchestration system is configured to cause a processor to execute, prompt creation processing of creating a prompt for a question from a user terminal, orchestration processing of transmitting the prompt created in the prompt creation processing to a generative AI processing unit to generate an answer to the question and of instructing the generative AI processing unit to refer to a tool when executing generative AI, and tool usage status monitoring processing of monitoring usage status of tool information referred to by the generative AI processing unit from a start of the question to the acquisition of an answer, and of calculating a tool usage rate.

### CROSS-REFERENCE TO RELATED APPLICATION

The present application claims priority from Japanese application JP2025-064760, filed on Jan. 9, 2026, the content of which is hereby incorporated by reference into this application.

### BACKGROUND

### Technical Field

The present invention relates to a generative AI orchestration system, a generative AI orchestration method, and a program.

### Related Art

Systems that utilize generative Artificial Intelligence (AI) to answer user questions have been widely implemented. For example, there is a question-and-answer system that accepts questions from users, who operate a plant or an infrastructure facility, about an operation method for the plant or the infrastructure facility or troubleshooting when an issue arises. At this time, the question-and-answer system utilizes generative AI to provide an answer addressing the question.

In this manner, a system that uses generative AI to provide answers generates a prompt corresponding to a question from a user, feeds the generated prompt to a processing unit of the generative AI, and obtains an answer. When generating an answer, the generative AI refers to a designated tool, such as a manual, to generate the answer. In this case, the generative AI itself determines and executes the tool to be referred to, but if a wrong tool is referred to at this time, the generative AI will generate a wrong answer.

For this reason, in a system that utilizes generative AI to provide answers, an operator of the system needs to monitor whether the provided answers are correct, and if the answers are not correct, work is required to correct the tool to be used and the like. Note that it is currently difficult to configure generative AI in the design phase of an answer system to ensure that it provides appropriate answers to all questions. Therefore, it is necessary for an operator of the system to monitor the answering state after starting the operation to make adjustments.

Patent Literature 1 discloses a technique for determining the validity of answers from generative AI by using a pre-trained logical decomposition model to break a question and a generated text into a plurality of logical sentences, and causing the generative AI to determine whether the logical inference is correct.

The technique disclosed in Patent Literature 1 is used to determine the validity of an answer through inference by preparing a logical decomposition model in advance, and cannot address questions unless an appropriate logical decomposition model has been prepared in advance.

### CITATION LIST

### Patent Literature

Patent Literature 1: JP 2024-179141 A

### SUMMARY

Conventional answer systems that utilize generative AI output a thought process of the generative AI as a log, and when monitoring the answering state, an operator of such a system needs to check the log indicating the thought process.

However, since a large number of logs of about 10 processes are output only for an answer to one question, and the logs indicating the thought processes contain enormous amounts of information, it takes a lot of time and effort for the operator to confirm whether a tool has been used correctly from the enormous information. Therefore, it is practically impossible for the operator of the system to monitor all answers from the answer system in detail, and it has been difficult to appropriately adjust the answer system using the generative AI.

An object of the present invention is to provide a generative AI orchestration system, a generative AI orchestration method, and a program that are capable of easily monitoring and adjusting an answering state of an answer system that utilizes generative AI.

In order to solve the above problem, for example, a configuration described in the claims is employed.

The present application includes a plurality of means for solving the above problem, and an example thereof is a generative AI orchestration system of the present invention that causes a processor to execute prompt creation processing of creating a prompt for a question from a user terminal, orchestration processing of transmitting the prompt created in the prompt creation processing to a generative AI processing unit to generate an answer to the question and of instructing the generative AI processing unit to refer to a tool when executing generative AI, and tool usage status monitoring processing of monitoring usage status of tool information referred to by the generative AI processing unit from a start of the question to the acquisition of the answer, and of calculating a tool usage rate.

According to the present invention, it is possible to easily confirm whether generative AI provides an answer by using an appropriate tool, based on a calculated tool usage rate.

Problems, configurations, and effects other than those described above will be clarified by the following description of an embodiment.

### BRIEF DESCRIPTION OF DRAWINGS

FIG. 1 is a block diagram illustrating a configuration example of a generative AI orchestration system according to an embodiment of the present invention;

FIG. 2 is a diagram illustrating an outline of a question, an answer, and monitoring by an operator using a generative AI orchestration system according to an embodiment of the present invention;

FIG. 3 is a flowchart illustrating a procedure of tool usage status monitoring processing according to an embodiment of the present invention;

FIG. 4 is a diagram illustrating an example of a metrics display field according to an embodiment of the present invention;

FIG. 5 is a diagram illustrating an example of a thought log according to an embodiment of the present invention; and

FIG. 6 is a block diagram illustrating a hardware configuration example of a computer as a generative AI orchestration system according to an embodiment of the present invention.

### DETAILED DESCRIPTION

Hereinafter, a generative AI orchestration system, a generative AI orchestration method, and a program according to an embodiment of the present invention (hereinafter, referred to as “present embodiment”) will be described with reference to the accompanying drawings.

### System Configuration

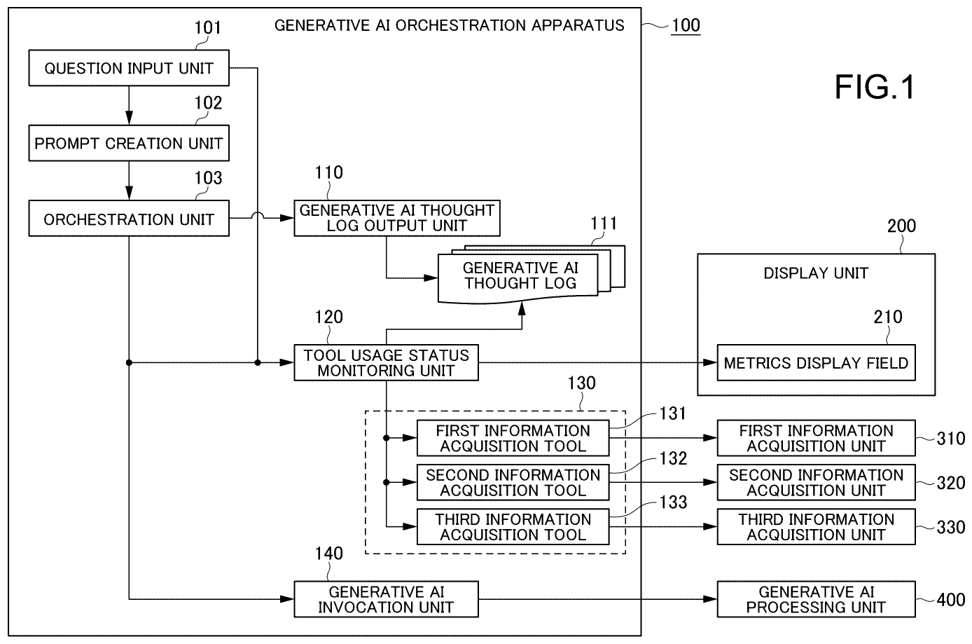

FIG. 1 illustrates a configuration of a generative AI orchestration system according to the present embodiment.

A generative AI orchestration apparatus 100 illustrated in FIG. 1 includes a question input unit 101, a prompt creation unit 102, an orchestration unit 103, a generative AI thought log output unit 110, a tool usage status monitoring unit 120, an information acquisition tool 130, and a generative AI invocation unit 140. Note that the generative AI orchestration apparatus 100 is constituted by a computer, as described later with reference to FIG. 8, and each processing unit is configured by executing a program implemented in the computer.

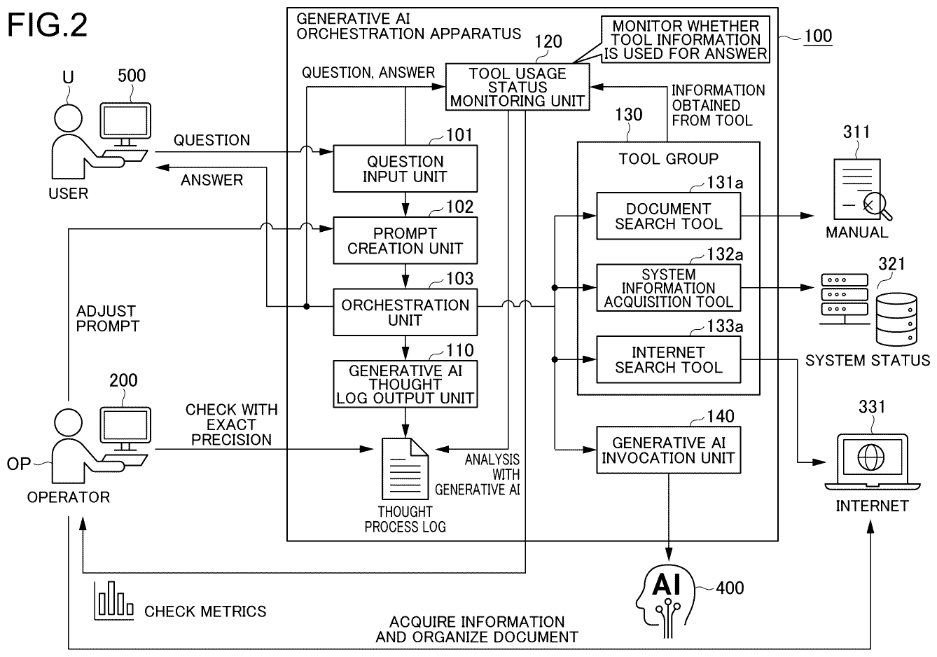

The question input unit 101 receives question data from a user terminal 500 (see FIG. 2).

The question data received by the question input unit 101 is transmitted to the prompt creation unit 102.

The prompt creation unit 102 creates a prompt, which is a text for inquiring of generative AI, based on the question data.

The prompt creation unit 102 stores prepared templates for prompts to be created corresponding to questions, and when a template is available for a question, the prompt creation unit 102 creates a prompt using the template. In addition, if no template is available, the prompt creation unit 102 creates a prompt using a text or the like contained in the question.

Note that a prompt creation processing status in the prompt creation unit 102 can be adjusted by an operator OP (see FIG. 2) of the system according to the present embodiment. For example, the operator OP can adjust the templates for prompts.

The orchestration unit 103 transmits the prompt created by the prompt creation unit 102 to the generative AI processing unit 400 via the generative AI invocation unit 140, and the generative AI processing unit 400 executes generative AI processing based on the prompt.

The generative AI processing unit 400 here is prepared outside the generative AI orchestration apparatus 100.

The generative AI invocation unit 140 invokes the generative AI processing unit 400 according to an instruction from the orchestration unit 103 to cause the generative AI processing unit to execute the generative AI processing based on the prompt.

When executing the generative AI processing, the generative AI processing unit 400 executes, according to the instruction from the orchestration unit 103, information acquisition processing using the information acquisition tool 130 necessary for executing the generative AI, and generates an answer with reference to the acquired information. That is, the orchestration unit 103 executes orchestration processing for an instruction for information necessary for executing the generative AI, and the generative AI processing unit 400 executes the generative AI processing with reference to the information.

In the example in FIG. 1, a first information acquisition tool 131, a second information acquisition tool 132, and a third information acquisition tool 133 are prepared as the information acquisition tool 130. The information acquisition tools 131, 132, and 133 access an external first information acquisition unit 310, second information acquisition unit 320, and third information acquisition unit 330, respectively, to acquire information.

Each of the information acquisition units 310, 320, and 330 is, for example, a database, a website, or the like, from which information regarding an assumed question related to an operation manual, design information, or the like of a plant or facility, about which the generative AI orchestration apparatus 100 according to the present embodiment receives a question, can be obtained.

In the orchestration unit 103, setting as to which information acquisition tool is to be used during the execution of the generative AI is performed in advance by the operator. The settings for the use of the information acquisition tool can be adjusted by the operator.

In addition, the orchestration unit 103 transmits a generative AI thought process log 111, which indicates a thought process when the generative AI processing unit 400 executes the generative AI processing, to the generative AI thought log output unit 110. The generative AI thought process log 111 is information acquired by the orchestration unit 103 from the generative AI processing unit 400 when the generative AI processing unit 400 executes the generative AI processing. Note that the generative AI thought process log 111 indicates a detailed thought process from the prompt until the generative AI processing unit 400 obtains the answer.

The tool usage status monitoring unit 120 monitors a tool usage status based on the question input to the question input unit 101, the instruction from the orchestration unit 103 to the generative AI invocation unit 140, and the generative AI thought log 111 output by the generative AI thought log output unit 110.

When monitoring the tool usage status based on the generative AI thought log 111, the tool usage status monitoring unit 120 compares information obtained from the information acquisition tools 131, 132, and 133 of the information acquisition tool 130 with the generative AI thought log 111, and calculates a tool usage rate.

The tool usage status monitoring unit 120 utilizes the generative AI processing in the generative AI processing unit 400 to calculate the tool usage rate.

The data about the tool usage rate, which is the tool usage status calculated by the tool usage status monitoring unit 120, is supplied from the tool usage status monitoring unit 120 to a display unit 200 and displayed. For example, the display unit 200 has a metrics display field 210 on its monitoring screen, and displays changes in the tool usage rate for questions as a graph.

### Monitoring Status During Execution of Question and Answer

FIG. 2 is a diagram illustrating an outline of a monitoring status by the operator OP when a user U asks a question and obtains an answer in the generative AI orchestration apparatus 100 illustrated in FIG. 1. Note that, here, the user U is a person who operates and monitors a system (plant, facility, or the like) about which the generative AI orchestration apparatus 100 according to the present embodiment provides an answer. The operator OP is a person who operates an answer system that uses the generative AI orchestration apparatus 100 and monitors its operation status.

As illustrated in FIG. 2, the user U transmits a question to the question input unit 101 using the user terminal 500. The question input unit 101 transmits the received question to the prompt creation unit 102, and the prompt creation unit 102 creates a prompt based on the received question.

The created prompt is supplied to the generative AI processing unit 400 via the orchestration unit 103 and the generative AI invocation unit 130.

Then, the generative AI processing unit 400 executes the generative AI processing while referring to each tool prepared as the information acquisition tool 130, and generates an answer.

The answer generated by the generative AI processing unit 400 is transmitted from the orchestration unit 103 to the user terminal 500 and displayed on the user terminal 500.

In the example in FIG. 2, a document search tool 131a, a system information acquisition tool 132a, and an internet search tool 133a, which are prepared as the information acquisition tool 130, search a manual 311, a system status 321, and the internet 331, respectively.

The manual 311 is documented data about an operation procedure and troubleshooting of the system, and is used when the generative AI orchestration apparatus 100 according to the present embodiment provides an answer.

The system status 321 is data indicating the current and past operating statuses of the system, and is used when the generative AI orchestration apparatus 100 according to the present embodiment provides an answer.

The internet 331 is a system used to search information published on the Internet for past answers to the question.

The generative AI processing unit 400 uses these tools 131a, 132a, and 133a when obtaining an answer through the generative AI processing.

Then, when the generative AI processing unit 400 generates an answer to the question, the tool usage status monitoring unit 120 monitors the tool usage status using the answer and the information obtained by the tools 131a, 132a, and 133a, and performs processing for calculating the tool usage rate. When the tool usage status monitoring unit 120 calculates the tool usage rate, the generative AI processing unit 400 executes analysis through the generative AI processing, for example. Then, the metrics of the tool usage rate are displayed on the display unit 200 of an operator terminal, which is checked by the operator OP.

The operator OP checks the metrics of the tool usage rate displayed on the display unit 200. When an abnormality, such as a decrease in the tool usage rate, is detected through this check, the operator OP performs work of checking the thought process log output by the generative AI thought log output unit 110. In checking the thought process log here, the operator OP can confirm a point where the tool usage rate is low with exact precision.

Once checking the point where the tool usage rate is low with exact precision, the operator OP adjusts prompts to be created by the prompt creation unit 102 and the like, based on the checked items. Then, the operator OP performs work of correcting the information acquisition tool 130 to be used in the generative AI processing when a question is asked. As a result, it is possible to improve the accuracy of answers during the execution of the generative AI in the generative AI processing unit 400.

### Procedure of Tool Usage Status Monitoring Processing

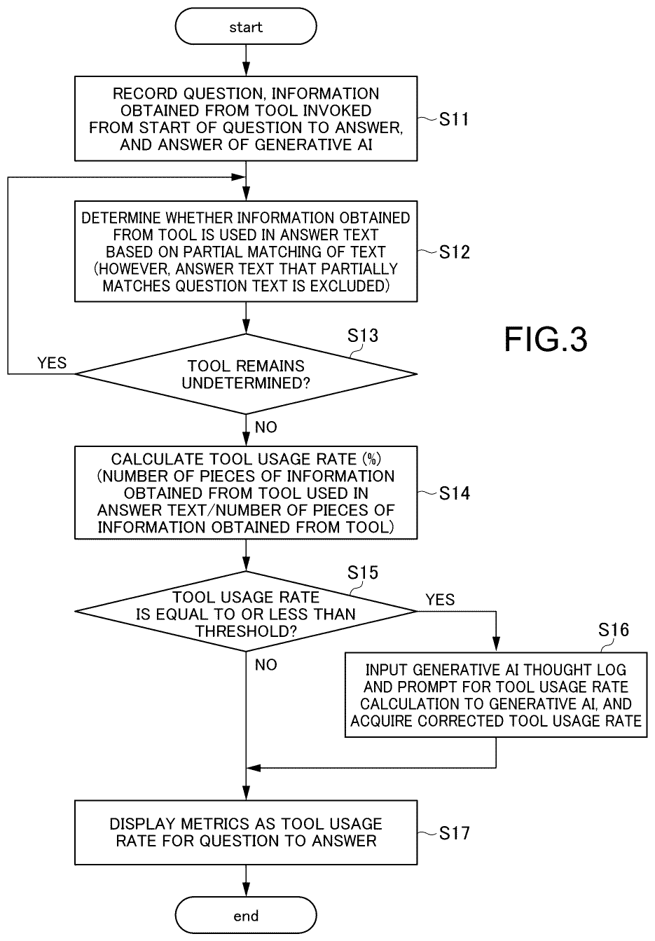

FIG. 3 is a flowchart illustrating a procedure of tool usage status monitoring processing by the tool usage status monitoring unit 120.

First, the generative AI orchestration apparatus 100 records a question from a user terminal, information obtained from a tool invoked between the start of the question and an answer, and the answer provided by the generative AI (step S11).

Then, based on partial text matching of the information recorded in step S11, the tool usage status monitoring unit 120 determines whether the information obtained from the tool has been used in answer text (step S12). However, the tool usage status monitoring unit 120 performs the determination by excluding an answer text that partially matches a question text.

Next, the tool usage status monitoring unit 120 determines whether a tool remains undetermined in the answer to one question (step S13). When determining in step S13 that a tool remains undetermined (YES in step S13), the tool usage status monitoring unit 120 executes the processing in step S12 on the undetermined tool.

When determining in step S13 that no tool remains undetermined (NO in step S13), the tool usage status monitoring unit 120 calculates a tool usage rate (%) based on the matching of the information from the determined tool with the answer text (step S14).

The tool usage rate is calculated by, for example, the following mathematical expression.

[(Number of pieces of information obtained from tool used in answer text)/(Number of pieces of information obtained from tool)]×100 [Expression 1]

However, when the answer is provided without invoking a tool, that is, when the generative AI can answer only with general knowledge, the tool usage status monitoring unit 120 sets the tool usage rate to 100%.

Then, the tool usage status monitoring unit 120 determines whether the tool usage rate calculated by [Expression 1] is equal to or less than a predetermined threshold (step S15). The threshold in the determination in step S15 is, for example, an intermediate value between 100% and 0% (for example, 50%).

This threshold may be appropriately set depending on the system, but when there is even one answer that does not use a tool, for example, the threshold may be set to 99%.

When the tool usage rate is equal to or less than the threshold in step S15 (YES in step S15), the tool usage status monitoring unit 120 transmits the generative AI thought log and a log analysis prompt for tool usage rate calculation to the generative AI processing unit 400 (step S16). As a result, the generative AI processing unit 400 obtains a corrected tool usage rate, which indicates the ratio of tool output necessary for the answer, through the generative AI processing.

Then, when the tool usage rate is not equal to or less than the threshold in step S15 (NO in step S15) and when the tool usage rate is corrected in step S16, the tool usage status monitoring unit 120 displays the metrics of the tool usage rate in the metrics display field 210 of the display unit 200 of the operator terminal (step S17).

### Specific Example of Tool Usage Rate

Next, a specific example in which the tool usage status monitoring unit 120 calculates a tool usage rate will be described. Here, tool information used for each question and answer, an answer, and a tool usage rate are described.

First, a good answer example 1, a bad answer example 1, and a bad answer example 2 are described.

In the good answer example 1, the question input from a user terminal is as follows:

“The following events are appearing on server managerA: “Failed to communicate with the alert management system” and “CPU usage status on server managerB exceeded the threshold (80%).” Please advise on the necessary procedures.”

One piece of the information from the tool corresponding to this question is as follows:

“Event message: Failed to communicate with the alert management system. Escalation Conditions: 1. Confirm that the events occurred after 01:00 on a weekday. 2. Confirm that the events occurred on a server between managerA and managerG. If all of the above conditions are met, escalation is required . . . .”

In addition, another piece of tool information corresponding to the question is as follows:

“Event Message: CPU usage status on server <server name> exceeded the threshold (x%).

Escalation Conditions: (1) Observe only if all of the following conditions are met.
The server is managerC.
The time is between 2:00 AM and 3:00 AM on Friday.”

Then, the answer generated by the generative AI processing unit 400 is as follows:
“The necessary procedure for the event on managerA server “Failed to communicate with the alert management system.” is as follows:
1. Confirm that the event occurred after 01:00 on a weekday . . . .

If all of the above conditions are met, escalation is required.

The necessary procedure for the event “CPU usage status on server managerB exceeded the threshold (80%).” is as follows:

Observe if the server is managerC, and the time is between 2:00 AM and 3:00 AM on Friday . . . .”

Take appropriate action following these procedures.”

In the case of the good answer example 1, since [the number of pieces of tool information contained in answer text=2] and the referred [tool information=2], the tool usage rate is 100%.

Note that, here, in the first tool information, the point used for the answer or the point using the tool information contained in the answer is the text, “Confirm that the event occurred after 01:00 on a weekday.” and “If all of the above conditions are met, escalation is required.”

In addition, in the second tool information, the point used for the answer or the point using the tool information contained in the answer is the text, “⋅The server is managerC. ⋅The time is between 2:00 AM and 3:00 AM on Friday.”

The bad answer example 1 is a case where information is acquired from a wrong tool.

In the bad answer example 1, the question input from the user terminal is as follows:

“The following event is appearing on the monitoring server: “Failed to communicate with the alert management system.” Please advise on the necessary procedures.”

No information has been obtained from the tool corresponding to this question, because the generative AI has referred to the document with the wrong tool.

Here, the answer generated by the generative AI processing unit 400 is as follows:

“We were unable to find any information regarding the procedure for failed communication with the alert management system. We propose general steps to address this issue. However, please note that these steps may vary depending on the specific system or environment.
1. **Confirm the network connection**: Communication failures with the alert management system may be caused by network connection issues. Please confirm the network connection from the monitoring server to the server running the alert management system.
2. **Confirm the status of the alert management system**: Confirm that the alert management system is operating normally. If it has stopped, restart the alert management system.”

In the case of the bad answer example 1, since [the number of pieces of tool information contained in answer text=0] and the referred [tool information=1], the tool usage rate is 0%.

The bad answer example 2 is a case where information that can be obtained from the tool is insufficient.

In the bad answer example 2, the question input from the user terminal is as follows:

“Communication with the process monitoring system has failed. Please advise which metrics should be checked to investigate the cause.”

The information from the tool referred to for this question is information from one tool only and is as follows:

“Sample system operation manual

Manual title: Escalation procedure for alert management system communication failures

Target event message: Failed to communicate with the alert management system.

Conditions for determining escalation necessity:
1. Confirm that the event occurred after 01:00 on a weekday.
2. Confirm that the event occurred on a server between managerA and managerG . . . ”

In the bad answer example 2, the answer generated by the generative AI processing unit 400 is as follows:

“We were unable to find specific metrics to investigate when communication with the process monitoring system fails. However, there are several points to consider when investigating communication failure in general: . . .

Based on the above information, you can use the relevant monitoring and debugging tools to investigate the cause of the communication failures in greater detail. These tools are used to check the network status, and the processing status of the process monitoring system, the usage status of the system resources, the log information, and other relevant data. For specialized troubleshooting and the use of monitoring tools, documentation and knowledge specific to the particular system environment, and tools are required.”

In the case of the bad answer example 2, the generative AI processing unit 400 has not used the information obtained from the tool for the answer. That is, the information from the tool referred to above is unrelated to the question, and even if the search information is changed and searched, no information is found. Therefore, since [the number of pieces of tool information contained in answer text=0] and the referred [tool information=2], the tool usage rate is 0%.

Next, a good answer example 2 is described. The good answer example 2 is a case where tool information is not contained in the answer text.

In the good answer example 2, the question input from the user terminal is as follows:

“The following event is appearing: Failed to communicate with the alert management system. Please advise on the number of servers to check.”

The information from the tool referred to for this question is as follows:

“Sample system operation manual

Manual title: Escalation procedure for alert management system communication failures

Target event message: Failed to communicate with the alert management system.

Conditions for determining escalation necessity:
1. Confirm that the event occurred after 01:00 on a weekday.
2. Confirm that the event occurred on a server between managerA and managerG.
3. Confirm that either: One or more events of the same type occurred within the hour before this event, or 10 or more events of the same type occurred within the past year . . . ”

Then, the answer generated by the generative AI processing unit 400 is as follows:

“Seven servers.”

In the case of the good answer example 2, since [the number of pieces of tool information contained in answer text=0] and the referred [tool information=1], the tool usage rate is 0%.

In the good answer example 2, the tool information is not contained in the answer text, but the “2. Confirm that the event occurred on a server between managerA and managerG” field in the tool information is used for the answer.

In the good answer example 2, a correct answer is provided using appropriate tool information, but the tool information itself is not contained in the answer text, and the tool usage rate is low.

In such a case, the generative AI thought log and the log analysis prompt for tool usage rate calculation are transmitted to the generative AI processing unit 400 to obtain the corrected tool usage rate.

By calculating the tool usage rate in this manner, the generative AI orchestration apparatus 100 can appropriately determine whether the answers provided by the generative AI are appropriate.

### Display Mode of Tool Usage Rate

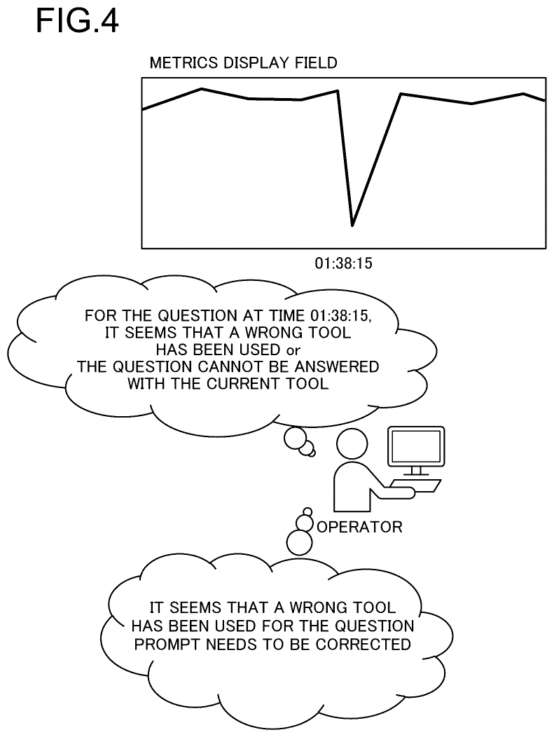

FIG. 4 illustrates an example in which a calculated tool usage rate is displayed on the operator terminal.

As illustrated in FIG. 4, in the metrics display field 210 of the display unit 200 of the operator terminal, changes in the tool usage rate, which is calculated by the tool usage status monitoring unit 120 that monitors the answers provided by the generative AI for questions, are displayed in time series. The horizontal axis in this display represents time, and the vertical axis represents tool usage rate.

In the example in FIG. 4, the tool usage rate displayed in time series indicates a decrease in the tool usage rate at a specific time [01:38:15].

The operator who has checked this display can determine that, “For the question at time [01:38:15], it seems that a wrong tool has been used or that the question cannot be answered with the current tool.”

Here, the operator can check the thought process log for the answer to the question at time [01:38:15], and can adjust the prompt and organize information and documents acquired from the tool, based on how the generative AI uses the tool, which is indicated in the checked thought process log.

That is, the operator has conventionally been required to check all thought process logs because there have been no metrics, such as the tool usage rate. However, in the case of the present embodiment, it is only necessary to check a point where the tool usage rate is low with exact precision, and it is possible to efficiently monitor the operation of the generative AI.

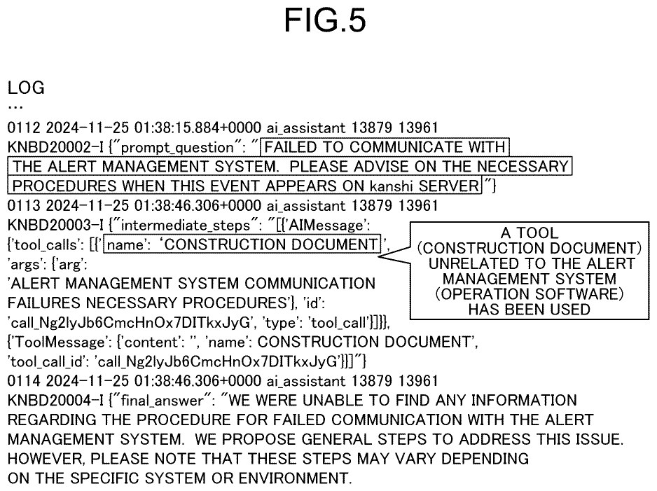

FIG. 5 illustrates an example of a question, an answer and a thought process log on the display unit 200 of the operator terminal when there is a decrease in the tool usage rate. This example is the case of the bad answer example 1 already described.

Here, the question is “The following event is appearing on the monitoring server: Failed to communicate with the alert management system. Please advise on the necessary procedures”, which is a question about the alert management system (operation software). Here, it can be seen from the thought process log that the generative AI provides an answer using delivery_docs (construction document), which is unrelated to the alert management system.

Specifically, the thought process log describes ““final answer”: We were unable to find any information regarding the procedure for failed communication with the alert management system. We propose general steps to address this issue. However, please note that these steps may vary depending on the specific system or environment.”

Note that, as an example of a proposal using a construction document, which is a tool unrelated to the alert management system as the operation software, indicated in the thought process log is, for example, as follows. It is also preferable that the following proposal is displayed simultaneously when the thought process log is displayed. “**Confirm the network connection**: Communication failures with the alert management system may be caused by network connection issues. Please confirm the network connection from the monitoring server to the server running the alert management system.

**Confirm the status of the alert management system**: Confirm that the alert management system is operating normally. If it has stopped, restart the alert management system.

**Check configuration files**: Check the configuration files to ensure communication settings for the alert management system are configured correctly. In particular, please confirm that the destination URL and port number are correct.

**Check logs**: Check the logs on the monitoring server or alert management system to find error messages that are causing the communication failure. The logs may contain detailed information about the cause of the communication failures.

**Check Firewall**: Depending on the firewall settings, communication from the monitoring server to the alert management system may be blocked. Check your firewall settings and enable communication if necessary.”

The operator who has checked the logs can improve the accuracy of answers generated by the generative AI by modifying the tools to be used by the generative AI and organizing documents.

### Hardware Configuration Example of System

The generative AI orchestration apparatus 100 illustrated in FIG. 1 is constituted by a computer.

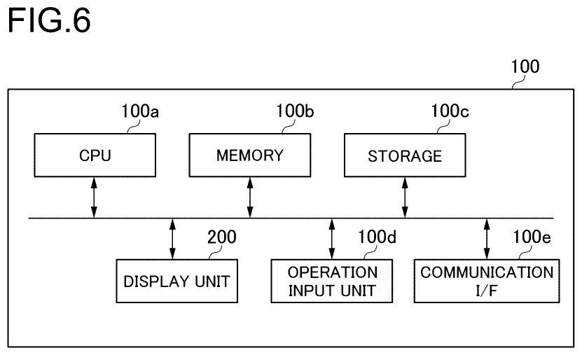

FIG. 6 illustrates a hardware configuration example of the generative AI orchestration apparatus 100, which is a computer.

As illustrated in FIG. 6, the generative AI orchestration apparatus 100 includes a central processing unit (CPU) 100a, a memory 100b, a storage 100c, an operation input unit 100d, and a communication interface (I/F) 100e. In addition, in the configuration illustrated in FIG. 6, the generative AI orchestration apparatus 100 includes the display unit 200 as an example.

The CPU 100a as a processor executes a program (software) stored in the memory 100b or the storage 100c to configure each processing function unit in the memory 100b. That is, the question input unit 101, the prompt creation unit 102, the orchestration unit 103, the generative AI thought log output unit 104, the tool usage status monitoring unit 120, and the generative AI invocation unit 140, which are illustrated in FIG. 1, are configured in the memory 100b under the control of the CPU 100a.

The memory 100b stores a program and has a work area for executing arithmetic processing under the control of the CPU 100a.

The storage 100c is constituted by a hard disk drive (HDD), a solid state drive (SSD), and the like, which store a large amount of data, stores a program, data to be referred to during arithmetic processing, an arithmetic processing result, and the like.

When a document or the like to be referred to as a tool by the generative AI orchestration apparatus 100 is stored, the corresponding document is stored in the storage 100c. In addition, data such as the generative AI thought log and the tool usage status is also stored in the storage 100c.

The operation input unit 100d is constituted by input devices, such as a keyboard and a mouse, and is used when the generative AI orchestration apparatus 100 is directly operated.

The communication interface 100e transmits and receives data between the generative AI orchestration apparatus 100 and external devices.

In addition, as illustrated in FIG. 6, when the generative AI orchestration apparatus 100 includes the display unit 200, the generative AI orchestration apparatus 100 itself may display the tool usage rate, the generative AI thought log, and the like. Note that the display unit 200 may be omitted from the generative AI orchestration apparatus 100.

In this manner, the generative AI orchestration apparatus 100 illustrated in FIG. 1 is configured by preparing the computer illustrated in FIG. 6 and storing the program that operates the computer as the generative AI orchestration apparatus 100 in the memory 100b or the storage 100c.

Note that the generative AI orchestration apparatus 100 configured by the computer illustrated in FIG. 6 is an example, and the generative AI orchestration apparatus 100 may be configured by another arithmetic processing apparatus other than the computer. For example, some or all of the functions performed by the generative AI orchestration apparatus 100 may be implemented by hardware, such as a field programmable gate array (FPGA) or an application specific integrated circuit (ASIC).

In addition, the use of a CPU as the processor included in the computer is also an example, and other processors, such as a micro processing unit (MPU) or the like, may be used.

### Modification

Note that the generative AI orchestration apparatus 100 illustrated in FIG. 1 is configured by one computer as an example, but a generative AI orchestration system may also be implemented by configuring each processing function unit with a separate apparatus. For example, an apparatus that obtains an answer using generative AI based on a question and an apparatus that monitors tool usage status may be separate apparatuses, and these apparatuses may transfer data with each other to function as a generative AI orchestration system.

In the configuration diagrams illustrated in FIGS. 1, 2, and 6, control lines and information lines considered to be necessary for the description are only illustrated, and not all control lines and information lines on a product are necessarily illustrated. In practice, it can be considered that almost all components are connected with each other.

In addition, the procedure of the processing illustrated in the flowchart illustrated in FIG. 3 is also an example, and if the processing results are the same, a part of the processing order may be changed, or multiple processing steps may be executed simultaneously.

Additionally, when the generative AI orchestration apparatus 100 described in the present embodiment is implemented by an information processing device, such as a computer, a program that achieves each processing function may be stored in a non-volatile storage or memory in a maintenance terminal 50. Alternatively, the program may be recorded in an external memory, IC card, SD card, optical disc, or the like, and transferred.

What is claimed is:

1. A generative AI orchestration system configured to cause a processor to execute:
prompt creation processing of creating a prompt for a question from a user terminal;
orchestration processing of transmitting the prompt created in the prompt creation processing to a generative AI processing unit to generate an answer to the question, and of instructing the generative AI processing unit to refer to a tool when executing generative AI; and
tool usage status monitoring processing of monitoring usage status of tool information referred to by the generative AI processing unit from a start of the question to the acquisition of the answer, and of calculating a tool usage rate.

2. The generative AI orchestration system according to claim 1, wherein
the tool usage rate calculated in the tool usage status monitoring processing is calculated based on matching of a text in the answer with a text in a document contained in the tool information.

3. The generative AI orchestration system according to claim 1, wherein
the tool usage status monitoring processing includes displaying changes in the tool usage rate in time series.

4. The generative AI orchestration system according to claim 2 configured to further cause the processor to execute generative AI thought log output processing of outputting a generative AI thought log during the execution of the generative AI in the generative AI processing unit, wherein
when the tool usage rate calculated in the tool usage status monitoring processing is equal to or less than a preset threshold, the generative AI thought log output processing includes outputting and displaying the generative AI thought log on an operator terminal.

5. The generative AI orchestration system according to claim 4, wherein
when the tool usage rate calculated in the tool usage status monitoring processing is equal to or less than the preset threshold, the prompt creation processing includes creating a prompt containing a thought log during the execution of the generative AI in the generative AI processing unit when the corresponding tool usage rate has been obtained, and a history when the tool usage rate has been calculated, and correcting the tool usage rate in the generative AI processing unit.

6. A generative AI orchestration method comprising:
creating a prompt for a question from a user terminal;
causing generative AI to provide an answer based on the generated prompt, and transmitting the acquired answer to the user terminal; and
monitoring the question and usage status of tool information referred to by the generative AI from a start of the question to the acquisition of the answer, and calculating a tool usage rate.

7. A program causing a computer to execute:
creating a prompt for a question from a user terminal;
causing generative AI to provide an answer based on the generated prompt, and transmitting the acquired answer to the user terminal; and
monitoring the question and usage status of tool information referred to by the generative AI from a start of the question to the acquisition of the answer, and calculating a tool usage rate.
